(19) United States
(12) Patent Application Publication
(10) Pub. No.: US 2019/0061071 A1
(43) Pub. Date: Feb. 28, 2019

(54) METHODS AND SYSTEMS FOR ENGINE IDLING WITHOUT A BATTERY

(71) Applicant: ILLINOIS TOOL WORKS INC., Glenview, IL (US)

(72) Inventors: Alan Smith, Fremont, WI (US); Jonathon Nelson, Kaukauna, WI (US)

(21) Appl. No.: 15/688,003

(22) Filed: Aug. 28, 2017

(51) Int. Cl. B23K 37/02; B23K 9/095; B23K 9/10

(52) U.S. Cl. CPC B23K 37/0258; B23K 9/1006; B23K 9/0953

(57) ABSTRACT

Systems and methods are provided for engine idling without battery in welding-type setups. An engine-driven welding-type power supply system may comprise an engine; a generator configured to convert mechanical power from the engine to electric power; a power conditioning circuit for converting output power from the generator to welding-type output power for use in welding-type operations; a controller configured to control operations of the engine; and a power supply component configured to provide power to the controller. Controlling operations of the engine may comprise automatically transitioning the engine to and/or from an idle mode (in which the engine idles); and the power supply component may be configured to provide power to the controller during at least the idle mode, and without use of a starting battery. The transitioning to and/or from idle mode may be done automatically.

### BACKGROUND

Welding can be performed in automated manner and/or in manual manner (e.g., being performed by a human). Equipment or components used during welding operations may be driven using engines. For example, engines may be used to drive, for example, generators, power sources, etc. used during welding operations.

In some instances, such as when there is pause or stop in welding operations, power may not be required (or not the same amount of power typically needed. Thus, engines may be switched to idle (e.g., run at lower speed) to reduce consumption. However, conventional approaches for idling engines in welding-type systems, if any existed, may be cumbersome, inefficient, and/or costly.

Further limitations and disadvantages of conventional approaches to implementing and utilizing thermal protection in welding-type systems will become apparent to one management of skill in the art, through comparison of such approaches with some aspects of the present method and system set forth in the remainder of this disclosure with reference to the drawings.

### BRIEF SUMMARY

Aspects of the present disclosure relate to welding-type operations. More specifically, various implementations in accordance with the present disclosure are directed to engine idling without a battery, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 shows an example system that may be used for welding-type operations, in accordance with aspects of the present disclosure.

FIG. 2 depicts an example power supply supporting engine idling without use of a starting battery, in accordance with aspects of this disclosure.

FIG. 3 depicts a flowchart of an example process for idling engines in welding-type setups use of starting batteries, in accordance with aspects of the present disclosure.

### DETAILED DESCRIPTION

Various implementations in accordance with the present disclosure are directed to providing enhanced engine idling, particularly without use of a conventional lead-acid battery (with only a light and small battery) or without any battery. In this regard, many welding-type systems (or setups) incorporate or use welding-type sources that are typically driven using an engine (e.g., gas engine, liquefied petroleum (LP) engine, or a Diesel engine). It may be desirable to idle these engines (e.g., reduce their speed as much as possible), under some conditions (e.g., during pauses or stoppage of welding operations), to reduce fuel consumption. The idling engines may be returned to normal operations, such as when the user wants to resume welding operations.

The engine idling (and resumption of normal engine operation) is typically controlled using controller circuitry in the system. This controller circuitry requires power supply, and is usually driven using the power supply component of the system. However, during engine idling power supply of the system may not be available, thus necessitating use of particular measures to provide the required power to the controller circuitry during engine idling.

In conventional systems control components draw power when the engines are idling from a starting battery—e.g., a 12- or 24-volt battery that is typically bulky and heavy (such as in lead acid batteries). The use of such starting batteries has various disadvantages, however. In particular, use of such starting batteries results in added complexity, such as with respect to mounting or incorporating such battery onto the system. Use of such batteries may take up space which could be used for other functionalities or components. Further, such batteries add significant weight to the system, which may be particularly undesirable in instances where welding systems are intended to be portable or configured for portable use.

Another disadvantage in conventional systems is that control of idling functions (e.g., transitioning to idle mode, resumption of normal operations from idling, etc.) is based on direct user interactions—e.g., direct user input to idle engine and/or resume normal engine operation. Thus, in conventional salutations a user would have to interact with the system to get it to idle down to a lower speed

Accordingly, it may be desirable to provide welding-type systems that provide enhanced engine idling functionality—e.g., where power supply, particularly to controller circuitry, when engine is idling is provided in enhanced manner (e.g., without adding much, if any, space or weigh, and preferably using as many existing components, as possible), and/or be done automatically (e.g., with no direct user interactions).

The present disclosure provides examples of welding-type systems having automatic engine idling functions without starting (e.g., cranking) battery. An advantage of such automatic engine idling system is reduced fuel consumption when no weld or auxiliary power is drawn from the machine as the engine runs at a reduced speed. Another advantage of such automatic engine idling system is that no special action by the user is required to cause the engine to idle down when no load is applied. In one particular implementation, existing charging coil in the engine may be used to supply power during engine idling. An advantage of using the charging coil in the engine is that no special electrical insulation of the low voltage idle control supply windings is required. In conventional systems, such insulation would be required if a winding in a generator having other high voltage windings was used.

An example engine-driven welding-type apparatus in accordance with the present disclosure may comprise an engine; a generator configured to convert mechanical power from the engine to electric power; a power conditioning circuit for converting output power from the generator to welding-type output power, for use in welding-type operations; a controller configured to control operations of the engine; and a power supply component configured to provide power to the controller. The controlling of operations of the engine may comprise automatically transitioning the engine to and/or from an idle mode; and the power supply component may be configured to provide power to the controller during at least the idle mode and without use of a starting battery. In this regard, such starting battery may be configured for use in only starting the engine. The transitioning to and/or from idle mode may be done automatically.

In an example implementation, the power supply component may comprise a regulator configured for providing the electric power at particular conditions associated with the idle mode. The regulator may be configured, for example, to provide 12 to 14 volt electric power.

In an example implementation, the power supply component may comprise a power generation element may be configured for generating power based on use and/or handling of the engine.

In an example implementation, the power generation element may comprise one or more charging coils. The one or more charging coils may be configured for use during normal operations of the engine.

In an example implementation, the power generation element may comprise a power supply component configured for generating the power based on rotational energy.

In an example implementation, the power generation element may comprise a dedicated power component configured for use only during the idle mode. The dedicated power component may comprise a winding for supplying power to the controller during the idle mode. Alternatively or in addition, the dedicated power component may comprise a transformer that is powered off of a generator used in the engine. Alternatively or in addition, the dedicated power component may comprise a power supply component derived from output power in the system. Alternatively or in addition, the dedicated power component may comprise a power supply component derived from control power in the system. Alternatively or in addition, the dedicated power component may comprise a non-starting battery.

In an example implementation, the engine may comprise a gas engine, a liquefied petroleum (LP) engine, or a Diesel engine.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “example” means serving as a non-limiting example, instance, or illustration. As utilized herein, the terms “e.g. and for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user- configurable setting, factory trim, etc.).

Welding-type power, as used herein, refers to power suitable for welding, plasma cutting, induction heating, CAC-A (carbon arc cutting/air) and/or hot wire welding/preheating (including laser welding and laser cladding). Welding-type power supply, as used herein, refers to a power supply that can provide welding-type power. A welding-type power supply may include power generation components (e.g., engines, generators, etc.) and/or power conversion circuitry to convert primary power (e.g., engine-driven power generation, mains power, etc.) to welding-type power.

Welding-type operations, as used herein, comprise operations in accordance with any known welding technique, including flame welding techniques such as oxy-fuel welding, electric welding techniques such as shielded metal arc welding (i.e., stick welding), metal inert gas welding (MIG), tungsten inert gas welding (TIG), resistance welding, as well as gouging (e.g., carbon arc gouging), cutting (e.g., plasma cutting), brazing, induction heating, soldering, and/or the like.

The term “automatically,” as used herein (and, particularly, with respect to engine idling functions), means without user interaction by an operator of the system.

The term “starting battery,” as used herein, means a battery that provides sufficient electrical current and/or voltage to enable engine cranking at speeds sufficient to start the engine.

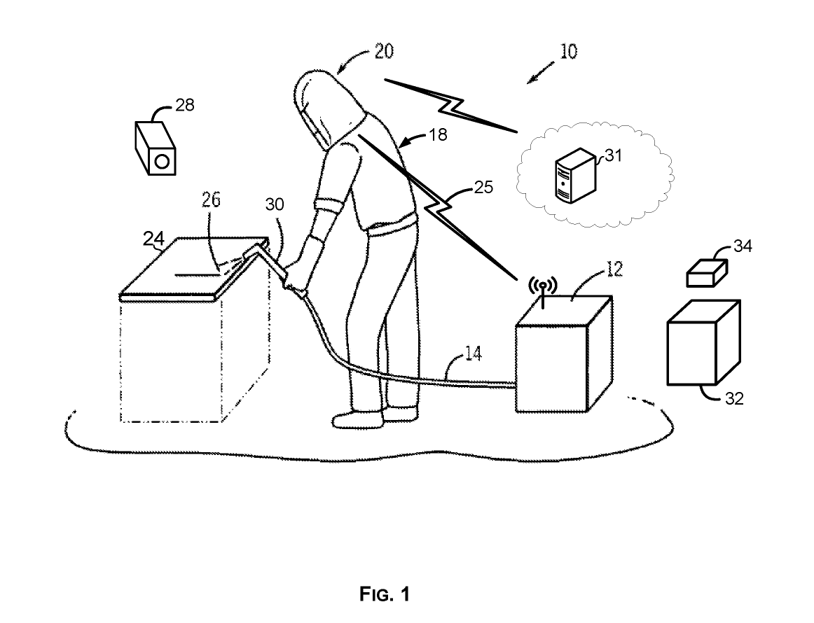

FIG. 1 shows an example system that may be used for welding-type operations, in accordance with aspects of this disclosure.

Referring to FIG. 1, there is shown an example welding-type setup 10 in which an operator 18 is wearing welding headwear 20 and welding a workpiece 24 using a torch 30 to which power is delivered by equipment 12 via a conduit 14, with weld monitoring equipment 28, which may be available for use in monitoring welding operations. The equipment 12 may comprise a power source, optionally a source of an inert shield gas and, where wire/filler material is to be provided automatically, a wire feeder. Further, in some instances an engine 32 may be used to drive equipment or components used during welding operations. The engine 32 may comprise a gas engine, a liquefied petroleum (LP) engine, or a Diesel engine. The engine 32 may drive generators, power sources, etc. used during welding operations.

The welding-type setup 10 of FIG. 1 may be configured to form a weld joint by any known welding-type technique.

Optionally in any implementation, the welding equipment 12 may be arc welding equipment that provides a direct current (DC) or alternating current (AC) to a consumable or non-consumable electrode 16 of a torch 30. The electrode 16 delivers the current to the point of welding on the workpiece 24. In the welding-type setup 10, the operator 18 controls the location and operation of the electrode 16 by manipulating the torch 30 and triggering the starting and stopping of the current flow. When current is flowing, an arc 26 is developed between the electrode and the workpiece 24. The conduit 14 and the electrode 16 thus deliver current and voltage sufficient to create the electric arc 26 between the electrode 16 and the workpiece. The arc 26 locally melts the workpiece 24 and welding wire or rod supplied to the weld joint (the electrode 16 in the case of a consumable electrode or a separate wire or rod in the case of a non-consumable electrode) at the point of welding between electrode 16 and the workpiece 24, thereby forming a weld joint when the metal cools.

Optionally in any implementation, the weld monitoring equipment 28 may be used to monitor welding operations. The weld monitoring equipment 28 may be used to monitor various aspects of welding operations, particularly in real-time (that is as welding is taking place). For example, the weld monitoring equipment 28 may be operable to monitor arc characteristics such as length, current, voltage, frequency, variation, and instability. Data obtained from the weld monitoring may be used (e.g., by the operator 18 and/or by an automated quality control system) to ensure proper welding.

As shown, the equipment 12 and headwear 20 may communicate via a link 25 via which the headwear 20 may control settings of the equipment 12 and/or the equipment 12 may provide information about its settings to the headwear 20. Although a wireless link is shown, the link may be wireless, wired, or optical.

Optionally in any implementation, equipment or components used during welding operations may be driven using engines. For example, the engine 32 may drive generators, power sources, etc. used during welding operations. In some instances, it may be desired to obtain information relating to used engines. For example, data relating to engines (and operations thereof) used during welding operations may be collected and used (e.g., based on analysis thereof) in monitoring and optimizing operations of these engines. The collection and use of such data may be performed telematically—that is, the data may be collected locally, subjected to at least some processing locally (e.g., formatting, etc.), and then may be communicated to remote management entities (e.g., centralized management locations, engine providers, etc.), using wireless technologies (e.g., cellular, satellite, etc.).

Optionally in any implementation, a dedicated controller (e.g., shown as element 34 in FIG. 1) may be used to control, centralize, and/or optimize data handling operations. The controller 34 may comprise suitable circuitry, hardware, software, or any combination thereof for use in performing various aspects of the engine related data handling operations. For example, the controller 34 may be operable to interface with the engine 32 to obtain data related thereto. The controller 34 may track or obtain welding related data (e.g., from weld monitoring equipment 28, from equipment 12, etc.). The controller 34 may then transmit the data (e.g., both engine related and weld related data), such as to facilitate remote monitoring and/or management, by way of wireless communications. This may be done using cellular and or satellite telematics hardware, for example.

In various example implementations, welding-type systems or setups, such as the welding-type setup 10, may be configured for optimizing operations, particularly by utilizing various measures or techniques for reducing fuel consumption. For example, in various implementations in accordance with the present disclosure, engines used in welding-setup (e.g., engine 32 in setup 10) may idle under certain conditions (e.g., after particular periods of no-use), and may then brought out of such idling. Further, the idling may be done with requiring use of batteries (or using non-starting batteries), as described in more detail below.

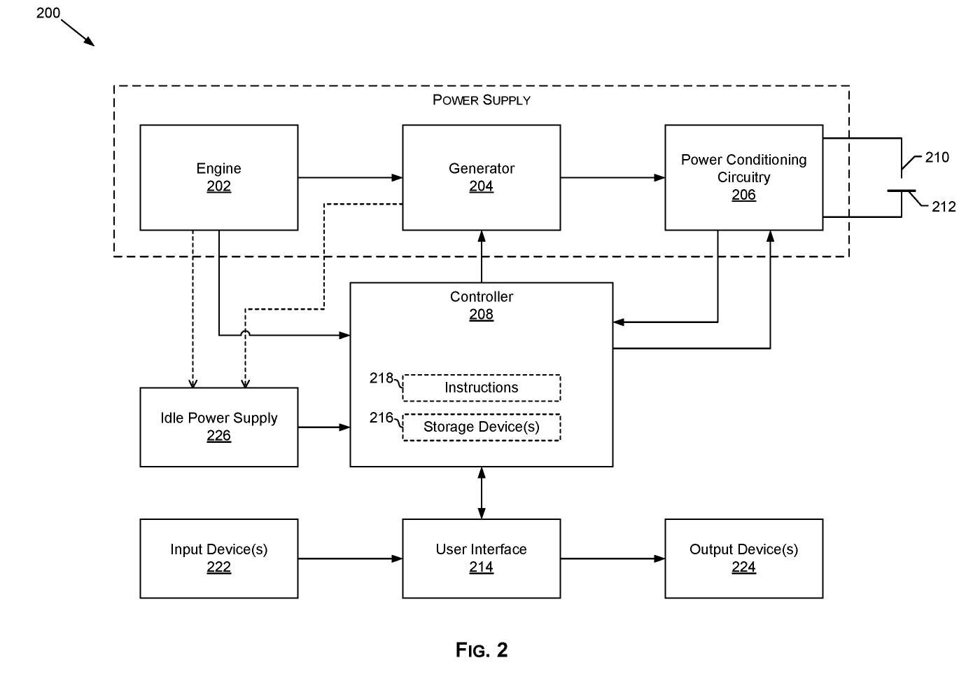

FIG. 2 depicts an example power supply supporting engine idling without use of a starting battery, in accordance with aspects of this disclosure. Shown in FIG. 2 is an example welding-type power supply 200.

The welding-type power supply 200, which may be engine driven. In this regard, the example welding-type power supply 200 may comprise, for example, an engine 202, a generator 204, and power conditioning circuitry 206.

The engine 202 may comprise a gas engine, a liquefied petroleum (LP) engine, or a Diesel engine. The engine 202 is mechanically coupled or linked to a rotor of the generator 204. The engine 202 may be controllable to operate at multiple speeds, such as an idle (e.g., no or minimal load speed) and a maximum speed (e.g., the maximum rated power of the engine 202). The engine speed may be increased and/or decreased, such as based on the load. The generator 204 generates output power based on the mechanical input from the engine 202.

The power conditioning circuitry 206 may comprise suitable circuitry for converting output power from the generator 204 to welding-type power based on a commanded welding-type output. For example, the power conditioning circuitry 206 provides current at a desired voltage to an electrode 210 and a workpiece 212 to perform a welding-type operation. The power conditioning circuitry 206 may comprise, for example, a switched mode power supply or an inverter. Power conditioning circuitry may include a direct connection from a power circuit to the output (such as to the weld studs), and/or an indirect connection through power processing circuitry such as filters, converters, transformers, rectifiers, etc.

In some instances, additional elements may be used, such as in controlling and/or supporting operations of the welding-type power supply 200 and/or functions associated therewith. In various example implementations, each of these additional elements may be implemented as a component of (incorporated into) the welding-type power supply 200, or as a separate, external device. As shown in FIG. 2, the additional elements may comprise a controller 208, a user interface 214, one or more input devices 222, one or more output devices 224, and an idle power supply 226.

The controller 208 comprises suitable circuitry for controlling operations of the welding-type power supply 200 and/or functions associated therewith. For example, the controller 208 may receive engine speed information (via engine input 203) from the engine 202, and may receive commanded engine speed and/or commanded welding- type output—e.g., as commands, obtain via the user interface 214. When the controller 208 determines that a load on the welding-type output is causing the engine speed to drop or to fail to accelerate to match the load, the controller 208 reduces the welding-type output from the commanded welding-type output to enable the engine speed to increase.

The user interface 214 comprises suitable circuitry for handling user input and/or user output, with the user input received via the one or more input devices 222 (e.g., switches, buttons, keypad, touchscreen, etc.) and the user output provided via the one or more output devices 224 (e.g., screen, audio devices, etc.). For example, the user interface 214 enables selection of a commanded power level or welding-type output, such as a current or voltage level to be used for welding-type operations. The user interface 214 additionally or alternatively enables selection of one or more speeds for the engine 202 (e.g., in RPM), such as an idle engine speed and/or engine speed under load.

In response to detecting a load or an increase in the load beyond the capacity of the engine 202, the controller 208 reduces the welding-type output of the power conditioning circuitry 206 from the commanded welding-type output by an amount proportional to a difference between the speed of the engine 202 and the commanded engine speed while monitoring the difference between the speed of the engine and the commanded engine speed. For example, if the engine 202 is at an idle speed when a load is added, the controller 208 decreases the welding-type output by a larger amount than if the engine decreases from the commanded speed due to an increased load on the engine. The controller 208 may monitor the difference between the speed of the engine and the commanded engine speed by comparing successive samples of the difference between the speed of the engine 202 (e.g., RPM feedback, via engine input 203) and the commanded engine speed to determine whether the difference is increasing, decreasing, or remaining the same.

When the controller 208 detects a condition to cause a decrease in the welding-type output, the controller 208 continues to decrease the welding-type output until the difference between the speed of the engine 202 and the commanded engine speed begins to decrease (e.g., when the engine 202 begins accelerating). As the different between the speed of the engine 202 and the commanded engine speed, the controller 208 increases the welding-type output until the welding-type output equals the commanded welding-type output.

The controller 208 controls the welding-type output by controlling the power conditioning circuitry 206 or by controlling a field current of the generator 204. For example, the controller 208 may decrease the welding-type output by decreasing at least one of a current output of the power conditioning circuitry 206 or a voltage output of the power conditioning circuitry 206. The controller 208 may control a switched mode power supply of the power conditioning circuitry 206 to reduce an output power and/or limit power consumed by the load connected to the power conditioning circuitry. Additionally or alternatively, the controller 208 may reduce the welding-type output by decreasing a magnitude of the field current in the generator 204 and/or increase the welding-type output by increasing the magnitude of the field current in the generator 204.

The controller 208 may include digital and/or analog circuitry, discrete or integrated circuitry, microprocessors, digital signal processors (DSPs), field programmable gate arrays (FPGAs), and/or any other type of logic circuits. The example controller 208 may be implemented using any combination of software, hardware, and/or firmware. The controller 208 executes machine readable instructions 218 which may be stored on one or more machine readable storage device(s) 216, such as volatile and/or non-volatile memory, hard drives, solid state storage, and the like.

In various example implementations in accordance with the present disclosure, the welding-type power supply 200, and related systems or devices, may be configured for enhanced performance (e.g., reducing fuel consumption), particularly by use of optimized idling schemes. In this regard, welding-type systems (or setups) that utilize engines in their power supply (e.g., the welding-type power supply 200) may be configured for idling these engines, such as during periods of non-use. Such engine idling may be controlled using control components (a dedicated controller, a general control component for the welding-type system, etc.).

In conventional solutions for idling engines have various disadvantages. For example, in conventional solutions control components draw power when the engines are idling from a starting battery—e.g., a 12-volt or 24-volt battery that is typically bulky and heavy. The use of such starting batteries results in added complexity, such as with respect to mounting or incorporating such battery onto the system. Use of such batteries may take up space which could be used for other functionalities or components. Further, such batteries can add significant weight to the system. This may be particularly undesirable in instances where welding systems are supposed to be portable or configured for portable use. Furthermore, in conventional solutions idling functions (e.g., transitioning to idle mode, resumption of normal operations from idling, etc.) are controlled through user interactions. Thus, in conventional solutions, a user would have to interact with the system to get it to idle down to a lower speed.

Accordingly, in various example implementations in accordance with the present disclosure, welding-type systems may be configured for supporting engine idling (e.g., to idle down and then resume normal operations) without the need for the user to interact with the system, and without requiring use of batteries or with light weight and small batteries (rather than starting batteries). Thus, the solutions proposed in accordance with the present disclosure allow for welding-type systems that are lighter, portable, and/or have room for added functionality.

For example, in the welding-type power supply 200, the controller 208 may be configured (e.g., programmed by incorporating suitable instructions 218) to transition the power supply into idle mode, whereby the engine 202 may be idles, and/or transition it out of the idle mode—e.g., to normal mode of operation. In this regard, the controller 208 may be configured to perform these transitions without requiring user interactions. For example, the controller 208 may be configured to transition the power supply to idle mode, whereby the engine is idling, based on particular, pre-define idling criteria that the controller 208 may utilize to perform such transitions independent of user interactions. The idling criteria may comprise, for example, periods of non-use, which may be tracked based on corresponding threshold (temporal or otherwise). In some instances, the idling criteria may be adjusted (and/or enable/disabled) by the user, such as via an input device 222.

Similarly, the controller 208 may be configured to transition the power supply from idle mode, such as based on particular, pre-defined resumption criteria, which the controller 208 may utilize to perform such transitions independent of user interactions. The resumption criteria may comprise, for example, detection of particular sensory information (e.g., user tugging on the conduit 14, user attempting to use torch 30, such as by pressing trigger therein, etc.). The resumption criteria may also comprise attempts to utilize auxiliary output(s) that are powered using the engine. In this regard, in some example implementations, welding-type power supply systems, such as system 200, may comprise one or more auxiliary outputs, to which auxiliary devices may be connected and powered on, resulting in auxiliary loads which may include, e.g., alternating current loads and/or direct current loads. Providing power via such auxiliary outputs may require the engine running at full speed. Thus, it may be desirable to include in the resumption criteria such actions as connecting auxiliary devices to the auxiliary outputs of the system. In some instances, the resumption criteria may be adjusted (and/or enable/disabled) by the user, such as via an input device 222.

The various components of the welding-type power supply 200 (and/or the welding-type system that incorporates the welding-type power supply 200) are typically driven by power provided by the welding-type power supply 200 during normal operations (when the engine 202 is running normally). Thus, a different power source may be needed to provide power during idle mode, particularly to the controller 208 which controls transitioning from the idle mode (back to normal mode of operation).

As noted above, in conventional systems idle power is provided by incorporating a starting battery. Instead, the welding-type power supply 200 may incorporate the idle power supply 226, which may be configured to supply power (particularly to the controller 208) during idle mode. The idle power supply 226 may be specifically configured for providing sufficient power, continually or on-demand, for continued operations during idle modes (e.g., to components that require power when the engine is idling), and with minimal (if any) space requirement and/or weight increase to the system. In various implementations the idle power supply 226 may incorporate dedicated components, and/or may be configured for utilizing existing components, for generating, regulating, and/or supplying the required power during idle mode.

In an example implementation, the idle power supply 226 may comprise (or be configured to use) charging coils already supplied in the system (e.g., in the engine 202 and/or the generator 204, such as for charging batteries, etc.). For example, the charging coils may be used to supply power to an electronic regulator (e.g., in the idle power supply 226), which may be configured to provide a nominal 12- volt power supply for powering control circuitry (e.g., the controller 208) used during idle mode and/or to other components (e.g., an idle solenoid). In this regard, charging coils typically supply power to a battery charging regulator, which requires a battery to be connected to operate, and as such when no battery is present the charging regulator does not function. The electronic regulator noted above is used to produce the required power supply (e.g., 12-volt power) from the charging coils without a battery, thus obviating the need for a battery in the system. The use of charging coils in the engine in the manner described herein also has the advantage of not requiring special electrical insulation of low voltage idle control supply windings. Such insulation would be required, such as if a winding in a generator (e.g., the generator 204) with other high voltage windings in it were used.

In another example implementation, a separate winding (e.g., in the generator 204) may be used, as an alternative to using the charging coils in the engine 202, to supply power during idle mode, to components requiring power in such mode (e.g., control circuitry, etc.).

In another example implementation, a transformer may be used to provide required supply power during idle mode. In this regard, the transformer may be supplied by the weld or auxiliary power generator windings. For example, the transformer may be powered by the generator 204.

In another example implementation, idle power supply 226 may be derived from output power of the system.

In another example implementation, idle power supply 226 may be derived from control power in the system. For example, a separate 12-volt power supply from the weld control system, such as a flyback power supply with an additional 12-volt winding, may be used provide required power supply during idle mode.

In another example implementation, idle power supply 226 may comprise a non-starting battery (e.g., lithium-based battery) for providing required power supply during idle mode. Such battery may be charged during normal operation of the system, and then used during idle mode.

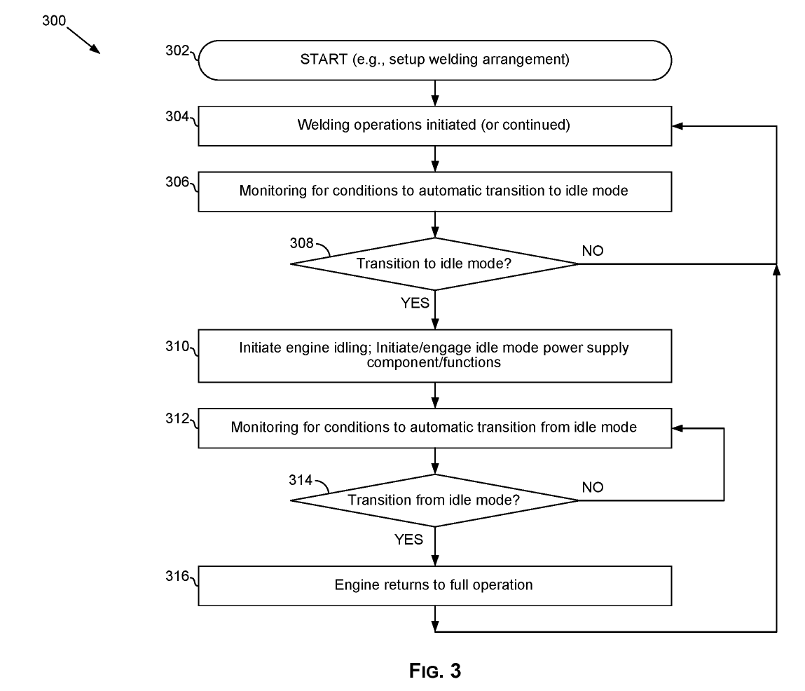

FIG. 3 depicts a flowchart of an example process for idling engines in welding-type setups use of starting batteries, in accordance with aspects of the present disclosure. Shown in FIG. 3 is flow chart 300, comprising a plurality of example steps (represented as blocks 302-316), for enhanced and automated engine idling in a suitable welding-type system (e.g., the welding-type power supply 200 of FIG. 2), in accordance with the present disclosure.

After start step 302, in which a welding arrangement (e.g., welding setup 100 of FIG. 1) is setup and configured for welding, welding operations may be initiated in step 304.

In step 306, conditions for automatic transition to idle mode may be monitored. For example, as described in FIG. 2, the controller 208 may monitor based on pre-defined idling criteria for conditions that indicate when/if to transition to idle mode. The conditions may comprise, e.g., particular period of non-use of the system.

In step 308, a check of whether to transition to idle mode or not, based on the monitored conditions, may be performed, and in instances where no transition is needed, the process may loop back to step 304 to continue welding operations. In instances where a transition to idle mode is needed, however, the process may proceed to step 310.

In step 310, the engine may be transition to idling (e.g., running at low/minimal speed to consume as much fuel as possible while still be able to resume full operations almost immediately). Further, idle mode power supply components and/or functions may be initiated and/or engaged.

In step 312, conditions for automatic transition from idle mode may be monitored. For example, as described in FIG. 2, the controller 208 may monitor, based on pre-defined resumption criteria, for conditions that indicate when/if to transition from idle mode (back to normal mode of operation). The conditions for transitioning from idle mode may comprise, e.g., the user acting in a manner that indicate the need to resume normal operations (e.g., pressing trigger on welding torch, etc.), attempts to utilize auxiliary output(s) that are powered using the engine, etc.

In step 314, a check of whether to transition from idle mode or not, based on the monitored conditions, may be performed, and in instances where no transition is needed, the process may loop back to step 312 to continue monitoring. In instances where a transition to idle mode is needed, however, the process may proceed to step 316.

In step 316, the engine may be returned to full operation (from idling), and the process may then return to step 304 to continue (or resume) welding operations.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. An engine-driven welding power supply system, comprising:
an engine;
a generator configured to convert mechanical power from the engine to electric power;
a power conditioning circuit for converting output power from said generator to welding—type output power for use in welding-type operations;
a controller configured to control one or more operations of said engine; and
a power supply component configured to provide power to said controller;
wherein:
said controlling of one or more operations of said engine comprises automatically transitioning said engine to and/or from an idle mode; and
said power supply component is configured to provide power to said controller during at least said idle mode and without use of a starting battery.

2. The engine-driven welding power supply system of claim 1, wherein said power supply component comprises a regulator configured for providing said electric power at particular conditions associated with said idle mode.

3. The engine-driven welding power supply system of claim 2, wherein said regulator is configured for providing 12 to 14 volt electric power.

4. The engine-driven welding power supply system of claim 1, wherein said power supply component comprises a power generation element configured for generating power based on use and/or handling of said engine.

5. The engine-driven welding power supply system of claim 4, wherein said power generation element comprises one or more charging coils.

6. The engine-driven welding power supply system of claim 5, wherein said one or more charging coils are configured for use during normal operation of said engine.

7. The engine-driven welding power supply system of claim 4, wherein said power generation element comprises a power supply component configured for generating said power based on rotational energy.

8. The engine-driven welding power supply system of claim 4, wherein said power generation element comprises a dedicated power component configured for use only during said idle mode.

9. The engine-driven welding power supply system of claim 8, wherein said dedicated power component comprises a winding for supplying power to said controller during said idle mode.

10. The engine-driven welding power supply system of claim 8, wherein said dedicated power component comprises a transformer that is powered off of a generator used in said engine.

11. The engine-driven welding power supply system of claim 8, wherein said dedicated power component comprises a power supply component derived from output power in said system.

12. The engine-driven welding power supply system of claim 8, wherein said dedicated power component comprises a power supply component derived from control power in said system.

13. The engine-driven welding power supply system of claim 8, wherein said dedicated power component comprises a non-starting battery.

14. The engine-driven welding power supply system of claim 1, wherein said engine comprises a gas engine, a liquefied petroleum (LP) engine, or a Diesel engine.

15. The engine-driven welding power supply system of claim 1, wherein said starting battery is configured for use in only starting said engine.
